(19) United States
(12) Patent Application Publication
(10) Pub. No.: US 2005/0065270 A1
(43) Pub. Date: Mar. 24, 2005

(54) Polymer composition

(75) Inventors: Klaus Knoerr, Hochstadt (DE); Hong Wen Chang, Fuzhou (CN)

Correspondence Address: TESTA, HURWITZ & THIBEAULT, LLP, HIGH STREET TOWER, 125 HIGH STREET, BOSTON, MA, 02110, US

(73) Assignee: Adidas International B.V., Amsterdam (NL)

(21) Appl. No.: 10/204,800

(22) PCT Filed: Mar. 2, 2001
(86) PCT No.: PCT/EP01/02403

(30) Foreign Application Priority Data
Mar. 2, 2000 (DE) 100 10 182.8

(51) Int. Cl. C08F 8/00

(52) U.S. Cl. 524/502; 525/191; 524/571; 524/493

(57) ABSTRACT

The present invention relates to viscous polymer composition, comprising at least a component, A) a polymer A, obtainable of at least a A1) C4- to C10-diene as monomer A1 as well A2) vinylaromatic C8- to C20-monomer as a monomer A2; B) a polymer B, obtainable of at least B1) C2- to C20-olefin as a monomer B1, B2) a monomer from a C2- to C10-vinylalcohol and C2- to C10-carboxylic acid as a monomer B2; and at least one of the components C) to E), C) a polymer C, obtainable from at least one vinylaromatic monomer; D) a halogen comprising polymer D, obtainable from at least one C4- to C10-diene and at least one halogen; E) a filler; or A) and B), or A) and B) with at least one of the components C) to E). The viscous polymer composition according to the invention is especially used for the sports industry to provide bodies with shock absorbing properties.

### 1. TECHNICAL FIELD

The invention is related to a viscous polymer composition, a process for producing said viscous polymer composition, a composite comprising said viscous polymer composition, shoe soles comprising said viscous polymer composition or said composite, respectively, as well as the use of the viscous polymer composition or of the composite, respectively, for producing bodies, in particular shoe soles.

### 2. GROUNDS OF THE INVENTION

By contacting the ground during walking, running or jumping forces are acting between the ground and the foot. The name of said forces are usually ground reaction forces (GRF). It can be determined with suitable measuring devices. The order of magnitude of GRF is usually 1-1,5 times the body weight (BW) of the athlete. During running the forces are 2-3 BW and during jumping forces of 5 and 10 BW were measured. The force-time-pattern shows in each kind of foot ground interaction two different phases. A hitting phase a) in the moment when the foot hits the ground, followed by a push phase b), whereby the athlete pushes himself in a forward and upper direction. FIG. 1a shows the landing movement of a foot during long distance running. Approximately 80% of all runners contact the ground with the heel first. FIG. 1b shows the subsequent pushing with the middle and front foot. The resulting vertical component of the GRF is depicted in FIG. 1c. According to this Figure, the curve shows two significant force maximum. The first maximum appears after 20-30 milliseconds (ms) caused by the hit of the heel. In the literature said force maximum is usually referred as “impactforce-maximum” since the human body does not react and adapt during said short interval. The second force maximum appears after 60 ms to 80 ms and is caused by the push. Said force-maximum is usually referred as “active-force-maximum” or “push-force-maximum”.

Said two kind of forces have different consequences with respect to the bone- and muscle-system:

Impact-forces do nothing to the forces of the athlete. Impact-forces have been considered to be relevant with respect to chronic and degenerative injures of several sports, in particular when the heel is involved. It is therefore one object, to reduce impact-forces by employing suitable constructions for shoe soles. Systems are intended, which easily deform under force and also disperse the energy.

The amount and the duration of the active forces determine the performance of the athlete, i.e. the running force and the jump heights. This means that a certain niveau of active forces has to be saved, when the athlete intends to run a certain speed. It is therefore intended to support such forces. A shoe sole can influence this, which minimizes the energy dispersion as much an possible and generates the necessary suppression at the same time.

Studies have proved that depending on the sport, running speed, anatomic form of the feet, etc. the relative height of the passive and active maximum to each other can vary. Therefore, depending on each single case the situation depicted in FIG. 1c can vary in a way that the active maximum has the same amount as the passive maximum or can also become bigger. However, it is the usual case that the maxima differ by approximately 60 ms.

With regard to the suppression systems in sport industry, the following solutions can be obtained from the state in the art:

From U.S. Pat. No. 5,695,850 a concept is known when a sport shoe is applied with a sole part, which should increase the performance of said shoe. This should be obtained by employing shoe- or sole components, respectively, which “regain” the energies, which occur during running and convert said energies in the push phase from the ground (also in the area of the active maximum in FIG. 1c) in a forward movement. For this reason the use of elastic materials either in the whole sole area or limited to the front foot area is disclosed. Suitable elastic materials like 1,4-polybutadiene/rubber, or—as a shoe inlet—a mixture of EVA and natural rubber are suggested.

From DE 87 09 757 a sole unit is known, consisting in a running sole and a intermediate sole, being fixed thereon. The intermediate sole is defined by a relatively small, frame-like circulating strip, which defines a unit, which is closed on its lower end by the running sole. Said unit carries two sole parts. One of those sole parts starts at the front foot area and ends at the beginning of the heel, where the second sole part is located. It is preferred that the first sole part consists in a polymer support inlet which has a relative high elasticity when pressure is applied, in a way that during walking with said shoe a foot bed can result on the sole part, which guarantees a certain comfort. The sole part which is located in the heel area builds a shock absorber and consists in shock absorbent, viscous material like silicone.

In a similar way U.S. Pat. No. 4,910,886 describes the use of shock absorbing inlets made of viscous material in the heel area of a sole unit.

U.S. Pat. No. 4,316,335 discloses the use of a viscous shock absorbing material in the front part of a sole as well as in the heel part, wherein the shock absorbing properties in the heel part should be better.

Furthermore, in U.S. Pat. No. 4,418,483 a shoe sole is disclosed, wherein in a layer composition the viscous material which is a polymer composition is implied as one possible layer. Said polymer composition consists in a cross-linked ethylene-vinylacetate copolymer (referred as EVA) and for increasing the tensile strength and other material properties, for example styrene-butadiene-rubber. Furthermore, in said polymer composition silica gel is implied as a filler and furthermore the usual aids for cross-linked rubber are used.

The above described known concepts have the drawback in common that the viscous material suggested therein are not adapted or optimized, respectively, or the above discussed time behavior of the passive and active force maximum in the heel area. For this reason, the desired effect is only unsatisfyingly accomplished and a “fuzzy” or “bouncing” feeling results during running. This causes a significant drawback in efficiency and safety of the forward movement of the runner who uses the shoe.

### 3. SUMMARY OF THE INVENTION

The object of the present invention is to provide a viscous material, in particular suitable for the passive and active force maximum occurring during the natural movement and which optimally uses a natural movement dynamic and thus provides a safe and efficient forward movement of the runner.

Moreover, it is desired that the viscous material can be used without bigger adaptations in known plants for producing shoe soles in a efficient and cheap manner.

According to the present invention the above objects are solved by a viscous polymer composition, which comprises and in particular contains:
A) a polymer A, obtainable of at least a
A1) C₄- to C₁₀-diene as monomer A1 as well
A2) a vinylaromatic C₈- to C₂₀-monomer as a monomer A2;
   or
B) a polymer B, obtainable of at least
B1) C₂- to C₂₀-olefin as a monomer B1,
B2) a monomer from a C₂- to C₁₀-vinylalcohol and C₂- to C₁₀-carboxylic acid as a monomer B2;
   and at least one of the components C) to E)
C) a polymer C, obtainable from at least one vinylaromatic monomer;
D) a halogen comprising polymer D, obtainable from at least one C₄- to C₁₀-diene and at least one halogen;
E) a filler;
   or A) and B) together on their own, or A) and B) together with at least one of the components C) to E).

Furthermore, the polymer composition according to the invention can contain the usual aids and additional compounds as for example to simplify removing the polymer composition from a mould.

### 4. DETAILED DESCRIPTION OF THE INVENTION

All possible combinations of the component A with the components B-E are preferred according to the present invention. Furthermore, the component B can be combined with the components C to E. In particular preferred combinations of the components are given by the following letter combinations: AB, AC, AD, AE, AEC, ABCD, BC, ABC, ABCDEF and ABCDE.

Furthermore, the viscous polymer composition is preferred, which contains components:
A) 0 to 99.9 wt-% polymer A, preferably 5 to 60 wt-%,
B) 0 to 99.9 wt-% polymer B, preferably 5 to 60 wt-%,
C) 0 to 99.9 wt-% polymer C, preferably 5 to 60 wt-%,
D) 0 to 90.4 wt-% polymer D, preferably 5 to 50 wt-%,
E) 0 to 40 wt-% fillers as component E, preferably 1 to 20 wt-%,
   wherein the sum of components A-E yields 100 wt-% and wherein the polymer composition always contains at least one of the two components A and B and if it contains A or B, it contains at least one further component C to E

The amount of component F if present is up to 15 wt-%, preferred from 0.5 to 5 wt-% in relation to the remaining polymer composition.

According to the present invention preferably C₄-C₈- and in particular preferred C₄-C₆- and moreover preferred C₄-C₅-dienes are employed as monomer A1. C₄-C₅-dienes are preferably butadiene and isoprene, wherein butadiene is in particular preferred.

Particularly C₈-C₁₅- and particularly preferred C₈-C₁₀-monomers are employed as monomer A2. α-methylstyrene and styrene are preferred and styrene is in particular preferred.

Polymer A is preferably a block polymer, which comprises at least one block of monomer A1 and one block of monomer A2. In particular preferred is a three block copolymer with on block of monomer A2 followed from one block of monomer A1 again followed by one block of monomer A2. A poly-(styrene-butadiene-styrene)-block copolymer as for example available under the trade name Styroflex® by BASF AG is in particular preferred.

Such poly-(styrene-butadiene-styrene)-blockcopolymers consist of “islands” of polystyrene as a hard fiber which are bedded in a matrix of rubber-like statistical styrene-butadiene-copolymer which makes the material flexible. Typically, these materials have a shore A-hardness (3s)15s, according to DIN 53505 in a range of (85 to 90) or 80 to 85 respectively. The shore D-hardness (3s)15s, measured according to DIN 53505, is in a range of (30 to 35) or 27 to 32 respectively. Furthermore, such materials have a low glass transition temperature in the range around −40° C. and a breaking temperature (according to DIN 53372) in a range of approximately −35° C. Further information about this material is given in the data sheets concerning Styroflex®, obtainable from BASF AG, Ludwigshafen.

Polymer B is a copolymer at least formed from the monomers B1 and B2.

The monomer B1 is preferably a C₂- to C₂₀- more preferably a C₂- to C₁₅- and in particular preferable C₂- to C₁₀-olefin. It is moreover preferred that monomer B1 is an alpha-olefin. In particular ethylene, propylene, 1-butene, 1-pentene, 1-hexene, 1-heptene, 1-octene and 1-nonene are preferred and ethylene as in particular preferred.

Monomer B2, being further employed in polymer B, is the product that is for example obtainable from a vinyl alcohol, in particular with 2 to 8 and more particular with 2 to 5 and even more particular with 2 carbons and a carboxylic acid with particular 2 to 8 and more particular 2 to 5 and even more particular 2 carbon atoms.

Polymer B can contain polymer B2 in a range from 5 to 25 and particular from 15 to 23 wt-%.

Particular preferred as polymer B is EVA(ethylene-vinylacetate)-polymer with a vinyl acetate content of 18 to 21 wt-%, based on the total polymer B in the viscous polymer composition according to the present invention. This EVA-polymer is supplied for example by Leuna Polymer GmbH, DuPont or Exxon.

Within this group of polymers, the content of vinylacetate as well as the melting index of the copolymerisation determine amongst others the mechanical and thermal properties of the polymer. With increasing content of vinylacetate, elongation, tension-tear stability, flexibility, cold resistance, rebound elasticity, tolerance and stickyness increase whereas hardness, stiffness, elasticity, vica temperature, bending stress and resistance towards chemicals decrease.

Further details concerning the properties and the composition of commercially available polymers B, especially of EVA polymers can be obtained from the corresponding data sheet of the above mentioned companies, like for example the data sheets regarding the product Miravithen® of Fa. Leuna Polymer GmbH and Elvax® of DuPont.

Polymer C is a polymer, obtainable from at least one vinylaromatic monomer, like for example styrene. Generally, such polymers are liquid in a temperature range from −10 to 100° C. Preferably, polymer C is liquid in a range from 0 to 70° C., especially preferred from 10 to 50° C. Regarding a C₄ to C₁₀-diene, reference is made to the explanation concerning monomer A1.

The halogens in polymer D are preferably fluorine, chlorine and bromine and in particular preferred bromine. With regard to the conjugated dienes employed in polymer D reference is made to monomer B 1. In polymer D bromo butadiene, bromo ispoprene are preferred and bromo butadiene is in particular preferred. Accordingly, poly bromo butadiene rubber is in particular preferred as polymer D.

As examples for materials which can be used as a polymer D, brominated copolymers of isobutene and isoprene have to be mentioned, which are availabel for example under the name Polysar® of Fa. Bayer AG. Further details regarding such polymers which can be used as polymer D are provided in the corresponding data sheet of Fa. Bayer AG.

As filler E all fillers know by the person skilled in the art can be used. Generally, fillers can be divided in inorganic and organic fillers. According to the present invention inorganic fillers are preferred. Said fillers particularly base on Si wherein silicon oxide are more preferred and silica is mostly preferred. Besides increasing the stability the use of fillers also increases the abrasion resistance of the viscous polymer composition.

Further fillers to be mentioned are for example: soot, calcium and aluminium silicates, aluminium oxide, kaolin, silica, french chalk, chalk and metal oxides, like for example zinc oxide and metal carbonates.

Above this, all known inorganic and organic pigments can be used as fillers, wherein pigments of titan oxide, zinc sulfide, iron oxide, chromium oxide, cadmium and chromate are preferred as inorganic pigments, and as organic pigments are especially preferred: diarylic- and pyrazolon-diazopigments, pigments of the β-naphtholcarboxylic acid or β-naphtholcarboxylic acid-arylits, derivatives of naphthalenetetracarboxylic acid or derivatives of peryleneteracarboxylic acid, pigments of dioxazine as well as pigments of chinacridon condensation products, thioindigo-isoindolinone condensation products and diazo condensation products.

Component F are aids and additional compounds which are well-known to the person skilled in the art. Aids are in particular activators, inhibitors, plasticizers, cross-linkers, separating agents, softeners and blowing agents in the case that the viscous polymer composition is a foam.

Activators can be inorganic or organic compounds. According to the present invention it is preferred that the viscous polymer composition contains a organic and an inorganic activator. Fatty acids are preferred organic activators, wherein sterenic acid is in particular preferred. Inorganic activators are in particular oxides of transition metals, wherein zinc oxide is in particular preferred.

Furthermore, it is preferred to add separating agents to the viscous polymer composition. The separating agents known to the person skilled in the art can be employed. In particular suitable are separating agents which are a salt of a fatty acid and a transition metal, wherein zinc stearate is in particular preferred.

Additionally, it is preferred to include softeners in the viscous polymer composition according to the present invention. Suitable softeners are known by the skilled person. Phthalates, adapenic acid ester and polyesters with rather low degree of polymerization are preferred. From these phthalates are in particular preferred, wherein di-octyl phthalate is in particular preferred in the viscous polymer composition according to the present invention.

If it is desired to obtain the viscous polymer composition as a foam, blowing agents can be used which are known to the person skilled in the art. Preferred blowing agents are halogen free carboxylic amides as for example the product ADC/K from Fa. Bayer AG or AC3000H.

The viscous polymer composition according to the present invention can be produced by a process, wherein the above mentioned components are brought into contact. Injection moulding is a preferred method for processing the polymer composition.

Furthermore, the viscous polymer composition according to the present invention is obtainable by bringing the above defined components into contact.

The viscous polymer composition according to the present invention comprises at least one of the following material properties:

An energy loss in the range of 50 to 80, preferably from 55 to 75 and more preferably from 60 to 70%,
a stiffness at 200 N to 400 N in the range of 80 to 150, preferably of 100 to 140 and more preferably of 110 to 130 N/mm,
a stiffness at 1000 N to 1500 N in the range of 100 to 400, preferably of 150 to 300 and more preferably of 170 to 270 N/mm,
a specific weight in the range of 0.3 to 0.8, preferably of 0.35 to 0.7 and more preferably of 0.4 to 0.45 g/cm³,
an elasticity in the range of 1 to 30, preferably of 5 to 20 and more preferably of 7.5 to 15%.

The polymer composition according to the present invention can have all possible combinations of the single properties a) to e). Preferred property combinations of the viscous polymer composition according to the present invention are given in the following letter combinations: ab, abc, abcd, abcde, bc, de, ac, ad, ae, ace, be, bd, and ce. In particular preferred is a viscous polymer composition with all properties a) to e).

Furthermore, the invention is related to a composite, comprising or preferably consisting in a viscous polymer composition according to the present invention and an elastic material.

The elastic material of the composite has at least one of the following properties:
α) an energy loss of <50, preferably <30 and more preferably <25%,
β) a stiffness at 200 N to 400 N in the range of >150 to 300, preferably of 170 to 290 and more preferably of 190 to 280 N/mm,
χ) a stiffness at 1000 N to 1500 N in the range of >400 to 700, preferably of 410 to 650 and more preferably of 430 to 600 N/mm,
δ) a specific weight in the range of 0.1 to 0.3, preferably of 0.15 to 0.28 and more preferably of 0.22 to 0.27 g/cm³,
ε) an elasticity in the range of >30 to 75, preferably of 40 to 70 and more preferably of 45 to 65%.

Preferably the elastic material of the composite can have the above defined properties a) to E) in all possible combinations. The following combinations are more preferred: αβ, αβχ, αβχδ, αβχδε, αχ, αχ, αε, βχ, βε, βχδ, βχβχδε, χε, χδε, δε. An elastic material in the composite with all the properties α) to ε) is most preferred.

In a preferred embodiment of the composite of the present invention the viscous polymer composition V1 and the elastic material V2 are directly adjacent to each other. This is in particular preferred when the composite only consists in the viscous polymer composition according to the present invention and the elastic material.

In another embodiment of the composite of the present invention the viscous polymer composition V1 and the elastic material V2 are separated at least in one part by at least one further material V3. Said composite preferably consists in the viscous polymer composition V1, the elastic material V2 and a further material V3. The elastic material V2 can be made of all suitable materials, in particular elastic polymers, known by the skilled person. The further material V3 differs from the viscous polymer composition V1 and the elastic material V2 in at least one material property, wherein the further material V3 preferably also differs with respect to its composition from the viscous polymer composition V1 and the elastic material V2.

Furthermore, the invention is related to a body, in particular a shoe sole, inlays for shoes, protectors, especially for elbow and shin, and shoulderpads, comprising, preferably consisting a viscous polymer composition or a composite according to the present invention.

Furthermore, the invention is rated to the use of a viscous polymer composition or a composite according to the present invention for producing of bodies, in particular shoe soles.

Above this, the viscous polymer composition according to the invention can be used to produce bodies in the whole area of healthcare and medical applications like for example health-shoes, orthopaedic shoes, orthopaedic inlays or elbowpads.

The term body generally means forms, foils, fibers, films and coatings. Bodies are preferred in which the properties of the viscous polymer composition or the composite according to the invention or both are favorably applicable.

### 5. BRIEF DESCRIPTION OF THE DRAWINGS

Preferred embodiments of the present invention are well described under reference of the following drawings, wherein it shows:

FIG. 1 The natural movement of the foot during running (FIGS. 1a to b) and the resulting GRF-force profile (FIG. 1c);

FIG. 2a A force-time-diagram of two force fields, which are applied from a measuring device according to the present invention on the heel area and the front foot area of a sole unit according to the present invention or material layers, respectively, to determined the energy loss according to the present invention and the dynamic stiffness;

FIG. 2b a measuring device according to the present invention used for applying the force profile according to FIG. 2a and for measuring the resulting deformation (and thus the energy loss and the dynamic stiffness);

FIG. 2c The force stamps used in a device according to FIG. 2b for the heel area and the front foot area;

FIG. 3 the deformation behavior of a viscous material with a resulting energy loss (hatched) and the dynamic stiffness DS between 1 Kn and 1.5 K n;

FIG. 4 the deformation behavior of elastic material with the resulting energy loss (hatched) and the dynamic stiffness (DS between 1 Kn and 1.5 Kn);

FIG. 5 a sole layer according to the preferred embodiment of the present invention, wherein in the front foot area an elastic material is used and in the heel area a viscous material is used;

FIG. 6a a cross-sectional view of an embodiment of the composite according to the present invention or a cut along the line A-A (or B-B, respectively), of the preferred embodiment shown in FIG. 5; and

FIG. 6b a cross-sectional view of an embodiment of the composite according to the present invention or a cut following the line A-A (or B-B, respectively), of the embodiment of FIG. 5.

### 6. DETAILED DESCRIPTION OF THE PREFERRED EMBODIMENTS

The preferred embodiments of the present invention are now described by the drawings which are not limiting the scope of the invention.

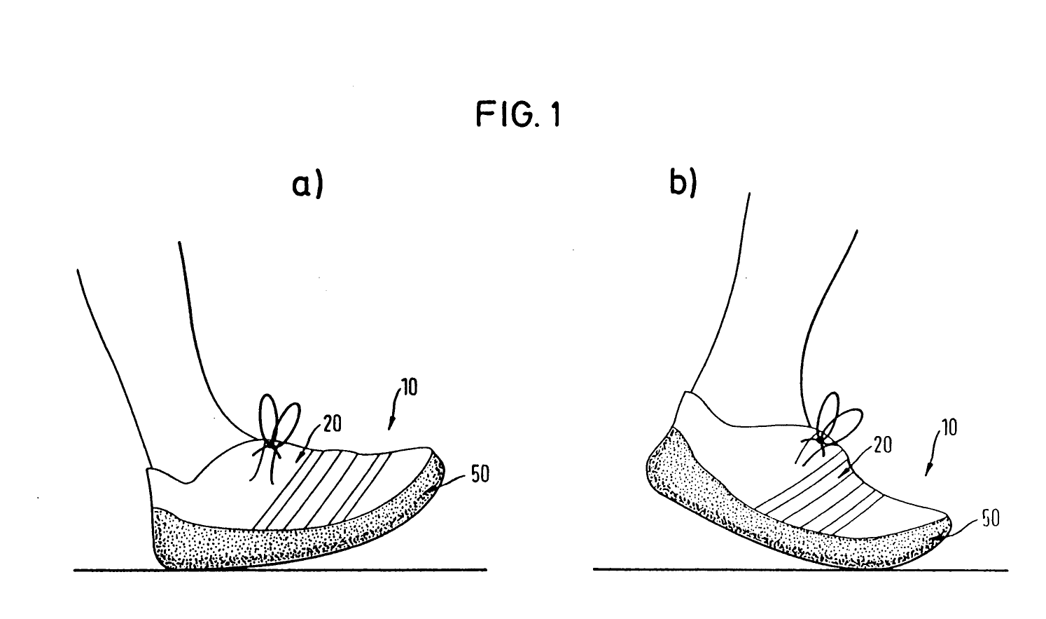

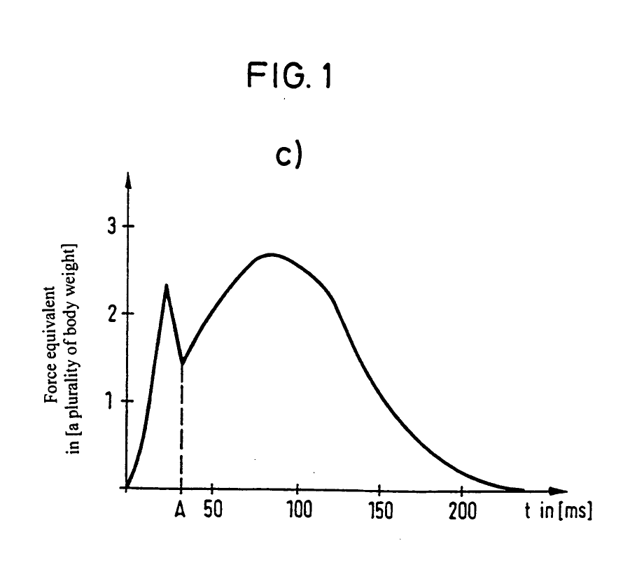

FIG. 1 depicts a human foot with a shoe 10 which essentially consists in a shaft 20 and a sole unit 50. As will be described in detail later, the sole 50 preferably consists in a plurality in layers which is further referred to as layer assembly.

To describe the principles according to the present invention, with regard to FIG. 1 a foot in its natural movement by walking or running, respectively, is described in detail.

As shown in FIG. 1a and in the introductory part, about 80% of humans start the movement by walking with contacting the heel area of a foot with the ground. In the moment of said contact a strong stroke is applied to the movement apparatus of the human. In the subsequent phase of the roll movement the applied force is reduced until the force increases in the moment of the push (reference is made to FIG. 1b). Therefore, the force-time-diagram depicts a curve with two maximums.

If for proving the above consideration a test person proceeds the movement typical for running on a force-time-measuring platform, the force profile according to FIG. 1c results. The ordinate shows that force equivalent (in a plurality of body weight) and the abscess shows the time in milliseconds. The diagram depicted in FIG. 1c is a GRF-diagram (since the forces which are applied during a step on the foot are called ground reaction forces (GRF) as already shown in the introduction).

As shown in FIG. 1c the GRF-curve has a first sharp maximum after 25 ms which results from a fast increasing force, which is equivalent to 2.5 times weight force as shown in the example of FIG. 1c. As already addressed in the introduction, this maximum is also referred to as vertical force impact peak-value (VFIPvalue). The phase in FIG. 1c from T=0 to T=A (approximately 30 to 35 ms) in the GFR-diagram is called passive phase. Said phase is related to the contact of the heel area of the foot on the ground (reference is made to FIG. 1a).

After the passive phase of moving the so-called active phase follows in the GRF-diagram. The second force increase in the active phase results from the push of the foot from the ground (reference is made to FIG. 1b). The stroke on the moving apparatus resulting from the active phase is much lower since a force appears slower compared to the active phase (approximately 60 to 70 ms). The GRF-diagram is strongly dependent from each single case and the conditions involved (running speed, anatomy of the foot, hardness of the ground, etc.).

Since the force increase of the passive phase occurs much faster as in the active phase, this results in a higher load of the heel, since the applied impulse (stroke) is comparably higher. Furthermore, by hitting a hard surface the impulse is “reflected” from the ground, so that the anatomy has to absorb said impulse. This yields, in particular during long lasting loads (example given marathon runs) to significant injuries or wear out, respectively.

Because of the smaller force impulse (longer force build up time) the load of the front foot area is lower. Furthermore, said front foot area has a bigger surface and an anatomic form, which allows a better absorption.

From his fact it was derived that the heel area needs better protection compared to the front foot area to avoid atomic damages. Since the forces in the front foot area occur slower, the foot is more capable to adapt to the increase of load (which is less here).

It is favorable for the front foot area that the sole has the property, wherein the component of the moving energy directing in the running direction is released as schematical energy in running direction and/or from the ground. Again, reference is made to FIG. 1b in this respect. If during the contact of the front foot with a ground genetical energy is again transferred to the foot, this yields in a reflection of the foot from the ground and thus, supporting the forward movement.

The present invention is thus based on the result that in the heel area and in the front foot area of a sole unit materials with different properties should be used: In the front foot area it is preferred to use an elastic material. In contrast to this, it is preferred to use a material obtained from the viscous polymer composition according to the present invention in the heel area.

From the above consideration it becomes apparent that the polymer characterization and the of the viscous polymer composition and the elastic material the energy loss occurring deformation is in particular suitable. This property (measured in %) describes the ratio of the energy applied to the material over the occurring force field to the energy obtained by relaxation.

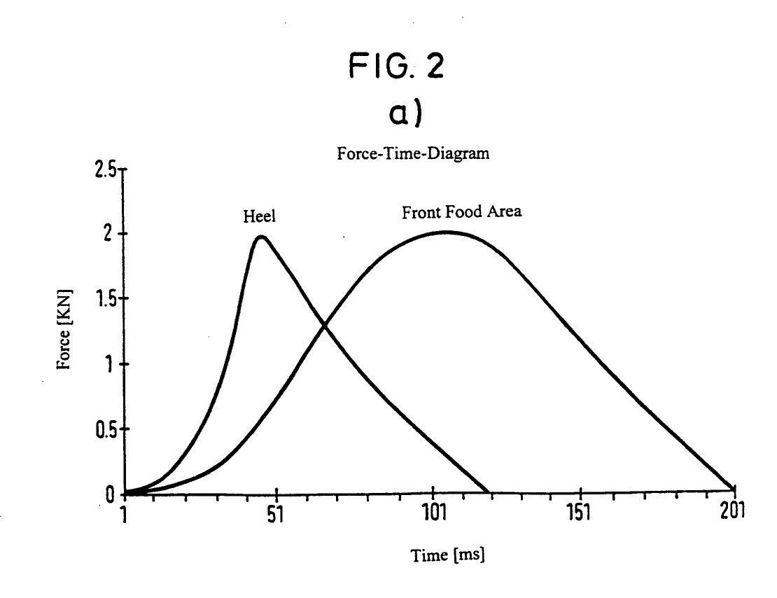

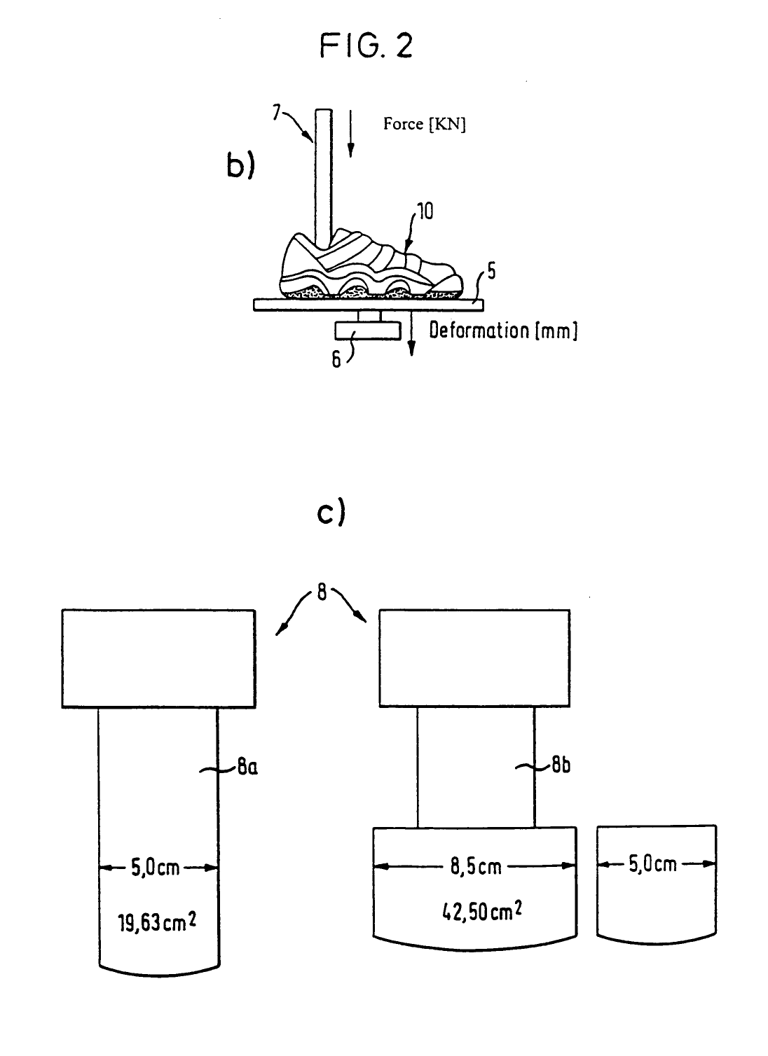

To determine the energy loss of suitable materials in the present invention the device according to FIG. 2b is used. Said device consists in a platform 5, with the material to be measured thereon. Said material can be a single material layer (preferred) or—as shown—a sports shoe. In each case, it is preferred that the investigated material is used with the same thickness and in particular in one of the same form, in which it is used in the shoe later on. On the material to be measured a defined force field is applied by the stamp device 7 via a stamp 8(as to be described bellow) (compare FIG. 2c). Below the platform 5 there is a (schematically depicted) measuring device 6 for measuring the deformation of the test materials (mm). The build up of the stamp device 7 and the measuring device 6 is well-known to the person skilled in the art. Besides the stamp 8 being described below such a device is commercially available under the name INSTRON UNIVERSALL 8502 of the company INSTRON Wolpert GmbH, Ulm.

The force field being implied by the stamp device 7 or stamp 8, respectively, has different profiles in the present invention for the test of the elastic and viscous materials to simulate reality as much as possible. Accordingly, for the testing of suitable viscous polymer a force field is applied, which is called “heel” in FIG. 2a. To be as close to reality as possible, furthermore, stamp 8a is used. The geometry of said stamp is equivalent to the human heel. Stamp 8a has a circular cross-section with a diameter of 5 cm and a cross-sectional area at the lower end of 19.63 cm² (which is slightly curved). For measuring elastic materials, a force profile is used, which is referred to “front foot” in FIG. 2a. The stamp 8b is in said measurements as adapted to the geometry of the human front foot. Stamp 8b has a lengthy form with a length of a 8.5 cm and is 5 cm broad. It is also (slightly curved). The lower side has a cross-sectional area of 42.50 cm². Finally, the materials are examined with a thickness which usually occurs in shoes (10 mm in the front foot area; 20 mm in the heel area).

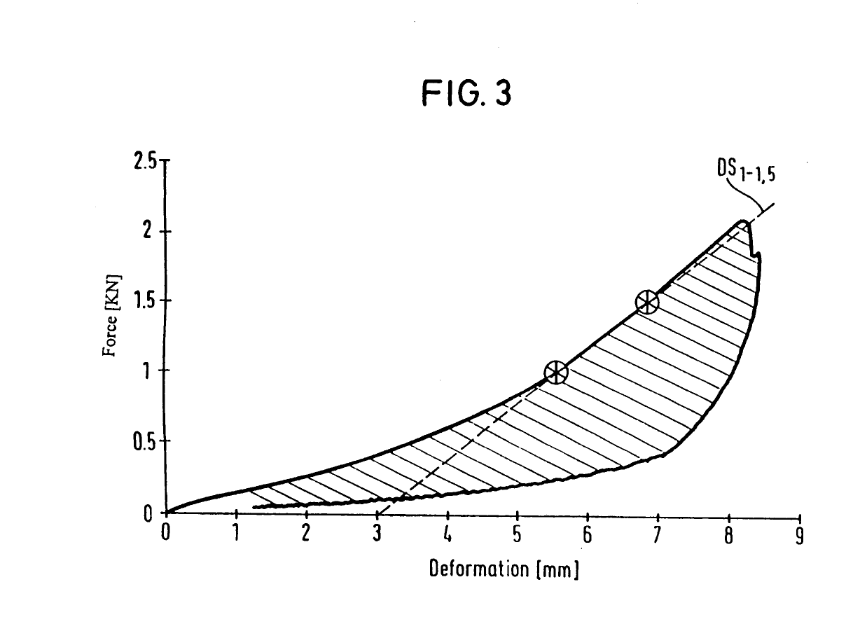

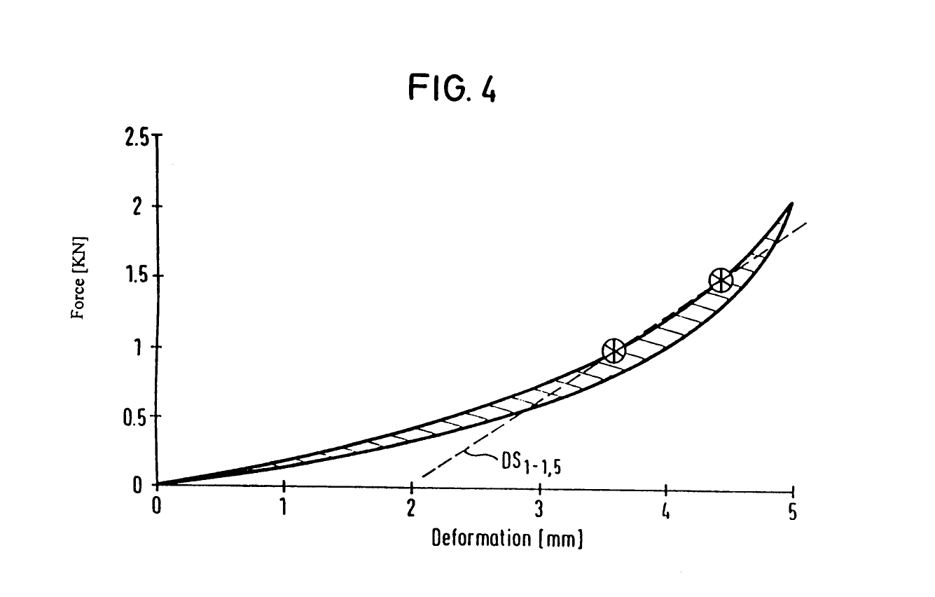

Below, with reference to FIGS. 3 and 4 the results obtained with the measuring devices 6 and 7 according to the present invention are discussed. In FIG. 3 the deformation behavior of a viscous polymer composition is shown. Said deformation behavior is obtained with the device of FIG. 2b and with a force profile “heel” in FIG. 2a, wherein the abscesses shows the deformation measured with device 6 depending on the force field applied with stamp 7. Said Figure shows that the viscous polymer composition according to the present invention which is preferably used in the heel area shows a strong hysterese behavior. When the force according to the force profile “heel” as shown in FIG. 2a, a deformation is obtained which relaxes slowly and with a significant lower counter force on stamp 8a. Said energy loss can be obtained graphical or numerical and is shown by the hatched area in the diagram. The diagram shows a significant part of the energy applied to the viscous polymer composition according to the present invention is changed into heat and is not available any more in the material when this relaxes to its original form.

The diagram from FIG. 3 shows besides the energy loss a further parameter which is important for the present invention, i.e. the dynamic stiffness (DS) of the tested materials. The dynamic stiffens is defined as the ratio between the applied force F (N) and the resulting movement d (mm). Experiments have shown that with respect to sport shoes two areas of dynamic stiffness are of particular interest: The stiffness between 1000 N and 1500 N as well as the stiffness between 200 N and 400 N. Said ratios can be calculated as follows:
Dynamic stiffness DS₁₀₀₀₋₁₅₀₀=(F_{1500N}−F_{1000N})/(d_{1500N}−d_{1000N})[N/mm]

The value of dynamic stiffness between 200 N and 400 N can be also calculated according to the above equation. Said value is not shown graphically in FIG. 3.

The dynamic stiffness is according to the present invention of interest of a sole unit which is a layer assemble (i.e. a plurality of layers from different materials). This of course is one preferred embodiment of the composite according to the present invention. Said assemblies (for example given with an inner layer, a middle layer which can comprise a function layer and an outer sole) show the above described effect according to the present invention only if the stiffness of the function layer is not higher than the stiffness of the materials of which the layers are made.

FIG. 4 shows the behavior of a preferred elastic material. As is shown in FIG. 4, the elastic material only shows a weak histerese behavior and thus only a very small energy loss. The material relaxes almost simultaneously when the force is reduced, wherein almost all the energy provided by force stamp 8b is released. The value for a dynamic stiffness between 1500 N and 1000 N is shown (the corresponding value for the dynamic stiffness between 400 N and 200 N is again not shown).

It becomes apparent that for field sports (basketball, volleyball, soccer) the dynamic stiffness between 1000 N and 1500 N should be lower as 600 N/mm for the elastic material and less than 250 N/mm for the viscous polymer composition.

However, for running shoes the dynamic stiffness of the elastic material between 1000 N and 1500 N should be less than 450 N/mm and the dynamic stiffness for the viscous polymer composition should be less than 200 N/mm.

For a shoe for universal application a good compromise is: The dynamic stiffness of the elastic materials between 1000 N and 1500 N should be less than 600 N/mm and between 200 N and 400 N less than 300 N/mm. The dynamical stiffness of the viscous polymer composition between 1000 N and 1500 N should be less than 250 N/mm and between 200N and 400N less than 130 N/mm.

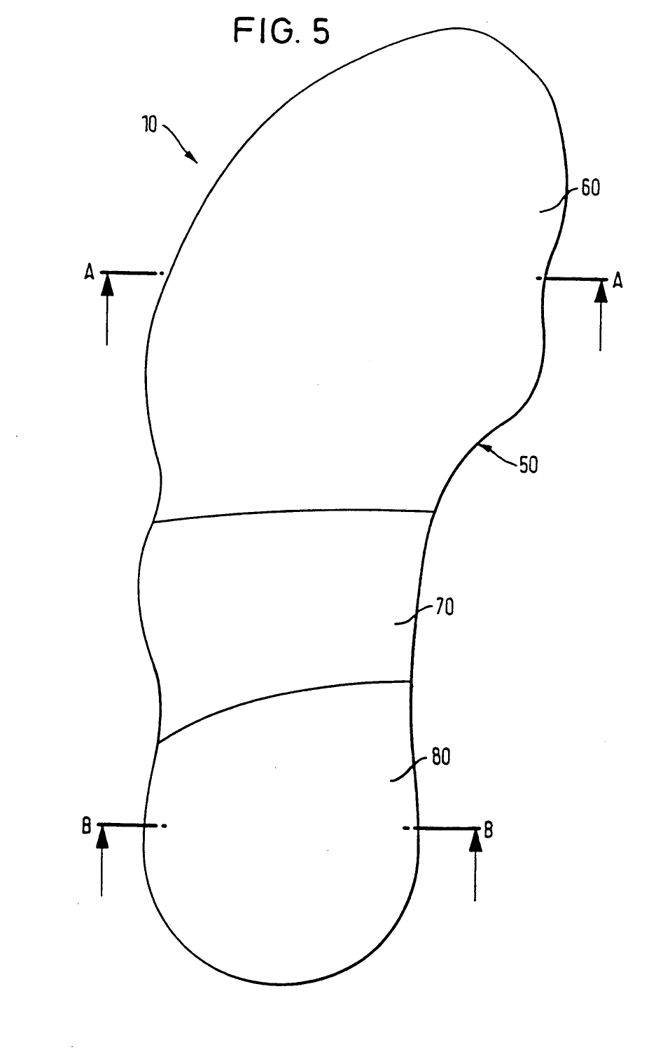

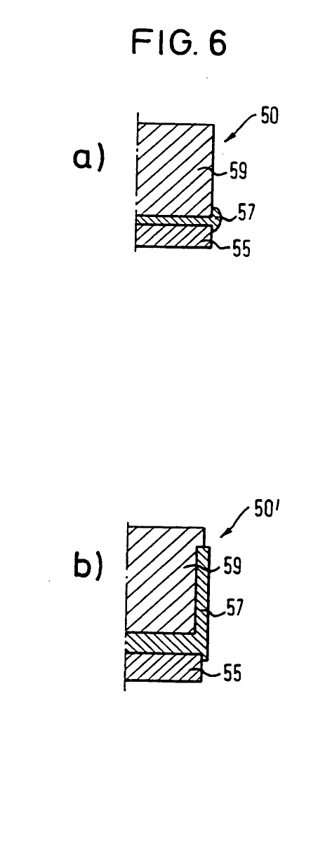

Taking the above materials into account, FIGS. 5 and 6 show preferred embodiments of soles according to the present invention.

FIG. 5 is a horizontal cut through a sole according to the present invention. There is a running sole 50 of a shoe 10 shown which is divided in a front foot area 60 and a heel area 80. The sole 50 itself can be a plurality of single layers as it is usually the case for sport shoes. For example, the sole can consist in an outer sole 55 and a middle sole 59 and not shown in a sole (compare FIG. 6a).

In a preferred embodiment according to the present invention there is between the outer sole 55 and the middle sole 59a function layer 57. Said function layer 57 can be divided in two horizontal areas, i.e. the front foot area 60 with elastic material and the heel area 80 with the viscous polymer composition. Between said two horizontal areas there can be a transition area 70. The front foot area 60 and the heel area 80 can also be in contact.

According to an alternative embodiment of the present invention (not shown) also two functional layers 57 can be present. In such a case the first function layer in the front foot area comprises the elastic material and the second function layer in the heel layer comprises the viscous polymer composition.

As shown in FIGS. 6a and 6b, the functional layer 57 can extend a little bit or a lot towards middle sole 59 (FIG. 6a). This depends on the application of the sport shoes. In cases, where the probability of the laterally hitting the ground is high (sports with jumps) the embodiment according to FIG. 6b is preferred. However, the embodiment according to FIG. 6a is for example applied to running shoes.

1. A viscous polymer composition, comprising:
D) a polymer D comprising a halogen, polymer D obtainable from at least one C₄- to C₁₀-diene and at least one halogen; and
at least one of
A) a polymer A, obtainable of at least a C₄- to C₁₀-diene as monomer A1 and a vinylaromatic C₈- to C₂₀-monomer as a monomer A2;
B) a polymer B, obtainable of at least a C₂- to C₂₀-olefin as a monomer B1, and a monomer from a C₂- to C₁₀-vinylalcohol and C₂- to C₁₀-carboxylic acid as a monomer B2;
C) a polymer C, obtainable from at least one vinylaromatic monomer; and
E) a filler.

2. A polymer composition according to claim 1, comprising:
A) 0 to 99.9 wt-% of polymer A,
B) 0 to 99.9 wt-% of polymer B,
C) 0 to 99.9 wt-% of polymer C,
D) 5 to 50 wt-% of polymer D,
E) 0 to 40 wt-% of fillers as component E,
wherein the sum of components A to E yields 100 wt-% and the polymer composition always contains at least one of the two components A and B and at least one of components C to E.

3. A polymer composition according to claim 1, wherein the polymer A is a block copolymer.

4. A polymer composition according to claim 3, wherein the block copolymer is obtainable from monomer A1 block surrounded by blocks of polymer A2.

5. A polymer composition according to claim 1, wherein E is a silicon oxygen compound.

6. (canceled)

7. A polymer composition according to claim 1, obtainable by bringing into contact the components.

8. A polymer composition according to claim 1, wherein the polymer composition comprises at least one of the following properties:
a) an energy loss in the range of 50 to 80%,
b) a stiffness at 200 N to 400 N in the range of 80 to 150 N/mm,
c) a stiffness at 1000 N to 1500 N in the range of 100 to 400 N/mm,
d) a specific weight in the range of 0.3 to 0.8 g/cm³, and
e) an elasticity in the range of 1 to 30%.

9. A composite, comprising:
a viscous polymer composition, comprising:
a polymer D comprising a halogen, polymer D obtainable from at least one C₄- to C₁₀-diene and at least one halogen; and at least one of
A) a polymer A, obtainable of at least a C₄- to C₁₀-diene as monomer A1 and a vinylaromatic C₈- to C₂₀-monomer as a monomer A2,
B) a polymer B, obtainable of at least a C₂- to C₂₀-olefin as a monomer B1 and a monomer from a C₂- to C₁₀-vinylalcohol and C₂- to C₁₀-carboxylic acid as a monomer B2, and
C) a polymer C, obtainable from at least one vinylaromatic monomer; and
an elastic material with at least one of the following properties:
a) an energy loss <50%,
b) a stiffness at 200 N to 400 N in the range of >150 to 300 N/mm,
c) a stiffness at 1000 N to 1500 N in the range of >400 to 700 N/mm,
d) a specific weight in the range of 0.1 to <0.3 g/cm³, and
e) an elasticity in the range of >30 to 75%.

10-11. (canceled)

12. A polymer composition according to claim 1, wherein the halogen is selected form the group consisting of fluorine, chlorine, and bromine.

13. A composition according to claim 9, wherein the halogen is selected form the group consisting of fluorine, chlorine, and bromine.

14. A sole for an article of footwear comprising:
a viscous polymer composition comprising:
a polymer D comprising a halogen, polymer D obtainable from at least one C₄- to C₁₀-diene and at least one halogen; and
at least one of a polymer A, obtainable of at least a C₄- to C₁₀-diene as monomer A1 and a vinylaromatic C₈- to C₂₀-monomer as a monomer A2, a polymer B, obtainable of at least a C₂- to C₂₀-olefin as a monomer B1 and a monomer from a C₂- to C₁₀-vinylalcohol and C₂- to C₁₀-carboxylic acid as a monomer B2, and a polymer C, obtainable from at least one vinylaromatic monomer.

15. A sole according to claim 14, wherein the viscous polymer composition further comprises a filler E.

16. A sole according to claim 15, wherein filler E is a silicon oxygen compound.

17. The sole of claim 14 further comprising an elastic material with at least one of the following properties:
a) an energy loss <50%,
b) a stiffness at 200 N to 400 N in the range of >150 to 300 N/mm,
c) a stiffness at 1000 N to 1500 N in the range of >400 to 700 N/mm,
d) specific weight in the range of 0.1 to <0.3 g/cm³, and
e) an elasticity in the range of >30 to 75%.
